(19) United States
(12) Patent Application Publication
(10) Pub. No.: US 2009/0020604 A1
(43) Pub. Date: Jan. 22, 2009

(54) METHOD FOR INFORMATION ARCHIVAL AND RETRIEVAL

(76) Inventor: Ernest W. MOODY, LAS VEGAS, NV (US)

Correspondence Address: JOHN EDWARD ROETHEL, 769 Basque Way, Suite 200, Carson City, NV, 89706, US

(21) Appl. No.: 12/175,323

(22) Filed: Jul. 17, 2008

Related U.S. Application Data
(60) Provisional application No. 60/950,206, filed on Jul. 17, 2007.

(51) Int. Cl. G06K 5/00

(52) U.S. Cl. 235/380

(57) ABSTRACT

Printed or published material is provided with a unique alpha-numeric code that is both in a machine-readable format and in a human-readable format. When the user picks an article or other information that the user wishes to save, he uses an access device that reads and scans the machine-readable code. The user could also enter the human-readable code. Periodically the device accesses an information service and transmits the stored codes. The user then obtains from the information service electronic copies of the articles which the user desires to archive. The information service organizes the articles in the user's personal virtual filing cabinet by subject based on the way the codes have been assigned or as designated by the user.

### CROSS-REFERENCE TO RELATED APPLICATION

This application is based on and claims the benefit of U.S. Provisional Application Ser. No. 60/950206, filed Jul. 17, 2007, the disclosure of which is incorporated herein in its entirety.

This application relates to a business method of organizing, archiving and retrieving written articles and other content. In particular, the application relates to providing each article with an access code embedded in the article so that the article can be easily stored and then retrieved at the convenience of the user.

### BACKGROUND OF THE INVENTION

GOOGLE has a much publicized project to organize all of the world's information. GOOGLE has proposed and is implementing the scanning and copying of books, newspapers and magazines to create an enormous database of information. The copyright owners of these books, newspapers and magazines have raised objections to GOOGLE's project.

Many readers of paper content such as books, newspapers and magazines would like to maintain reference copies of the articles that they read. Traditionally, readers would take the article they wish to save to a photocopying machine and make a paper copy. Alternatively, they simply tear out the pages or cut out the article and stash the article in a physical file folder for later access.

There are many disadvantages to this method of saving articles. The paper upon which such articles are printed usually has a very short shelf life. There is no way to easily search through the paper copies to retrieve desired information. The file folders can become large over time and the physical storage space needed to maintain these file folders can become prohibitive. Indexing these articles for easy retrieval is not a simple task.

Various bar code systems have been used to identify products with the most widely known system being the Uniform Product Code (UPC) system in which each article to be sold at a store is given a UPC bar code identifier. By using a scanner, the identity of the article can be retrieved from the store's computerized database and the price of the article is displayed at the check out location in the store. The price is no longer required to be attached to each article saving time and improving the efficiency of the sales process.

U.S. Pat. No. 6,959,308 (Gramsamer et al.) discloses a method and apparatus for maintaining an organized and automated archiving and retrieval system. The patent discloses having a user create a personal archive of both original real objects as well as an electronic archive containing copies of the original real objects with guaranteed access thereto. Each object has a machine and/or human readable unique identifier established and controlled by the service provider of the object. The publisher of the object attaches the unique identifier to the object when it is distributed. The user can read the unique identifier using a simple reader device that will enter the unique identifier electronically into the user's personal archive. The disclosure of this U.S. Pat. No. 6,959,308 is incorporated in its entirety herein by this reference.

U.S. Pat. No. 7,055,737 (Tobin et al.) discloses an invention related to electronically obtaining from a remote location topic-specific information about a product. The disclosure includes having each product provided with a human-readable code and a machine-readable code (such as a bar code) by which a user may access an appropriate Internet site to obtain information about the product.

There is a need to provide a system in which a user can easily access, archive and retrieve written material.

### SUMMARY OF THE INVENTION

A component of information can be printed or published material, such as books, magazine articles or newspaper articles, either in toto or in designated portions of the entire book or article. Each component of information is provided with a unique alpha-numeric code that is both in a machine-readable format, such as a bar code, and in a human-readable format. When the user picks up a book, magazine or newspaper that contains an article or other information that the user finds interesting and wishes to save, he uses an access device that reads the machine-readable code and scans the code into the device. The user could also enter the human-readable code into a device that saves the code.

On a periodic basis or as determined by the user, the access device that has the saved codes accesses an information archival service and transmits the stored codes from the user's device. The user then accesses the information archival service and obtains electronic copies of the components which the user desires to archive. The information archival service organizes the articles in the user's personal virtual filing cabinet by subject matter based on the way the codes have been assigned or as designated by the user.

The information service can bill on a per-article basis or by a daily, weekly or monthly fee for a limited or an unlimited quantity of information.

### BRIEF DESCRIPTION OF THE DRAWINGS

FIG. 1 shows a flow chart depicting the method and apparatus of the present invention.

FIG. 2 shows a flow chart depicting the method and apparatus of the user's virtual filing cabinet.

### DETAILED DESCRIPTION OF THE PREFERRED EMBODIMENTS

Many people read books, magazines and newspapers. While reading, there always seem to be articles or other information that the reader wishes to save for future reference. Other than clipping the articles, physically tearing out the pages or making photocopies, there is not a convenient way to maintain archives of the articles. These paper copies are quite inconvenient and attempting to file, organize, recall and search these paper copies is problematical.

The present invention provides that every component of information such as a book, magazine article or newspaper article, either in toto or in designated portions thereof, have a unique alpha-numeric code in a machine-readable format, such as a bar code, and a human-readable code that uniquely identifies the component of information of the book, magazine article or newspaper article.

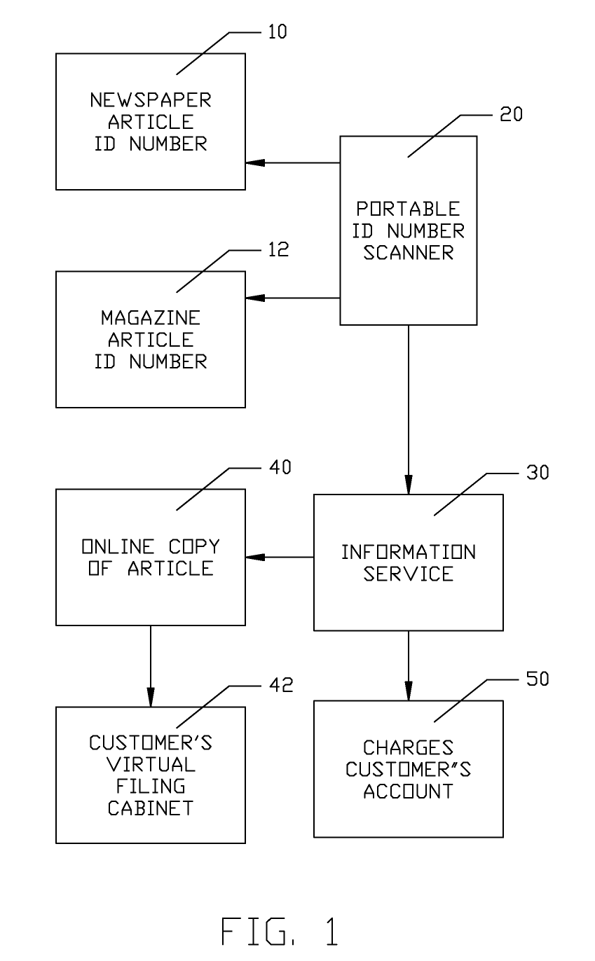

As shown in FIG. 1, the publisher of the newspaper article assigns an ID number 10 to each article according to a standardized system, preferably using an alpha-numeric code. The print copy of the newspaper article will include this code in both a human-readable format and a machine-readable format, such as a bar code format.

Likewise, the publisher of the magazine article assigns an ID number 20 to each article according to a standardized system, preferably using an alpha-numeric code. The print copy of the magazine article will include this code in both a human-readable format and a machine-readable format, such as a bar code format.

The standardized system could include an appropriate identifier as part of the code to differentiate between newspaper articles and magazine articles.

Similarly, book publishers could also participate in this standardized system so that entire books, chapters thereof or other identifiable component parts of a book could be included in the present invention.

When a reader picks up a book, newspaper or magazine and finds an interesting article that he wants to save, the reader can record the alpha-numeric code that identifies the article. The reader uses a suitable portable ID number scanner 20. In one embodiment, the reader uses his cell phone and either types in the human-readable code or scans machine-readable code with a bar code reader that is part of the cell phone. Since the publisher has included the alpha-numeric code at the beginning of the article, this step is quite easy to accomplish.

Periodically or whenever the user desires, the portable ID number scanner, such as the cell phone, dials in or otherwise connects to an information archival service 30 and uploads to the information archival service the codes that have been scanned into and stored in the scanner. The information archival service provides the necessary billing services by charging the reader's account 50 and distributing the fees among the various publishers who participate in the system.

The information archival service also maintains an online copy 40 of the article identified by the reader and stores this online copy in the reader's virtual filing cabinet 42 which is maintained on the server of the information archival service.

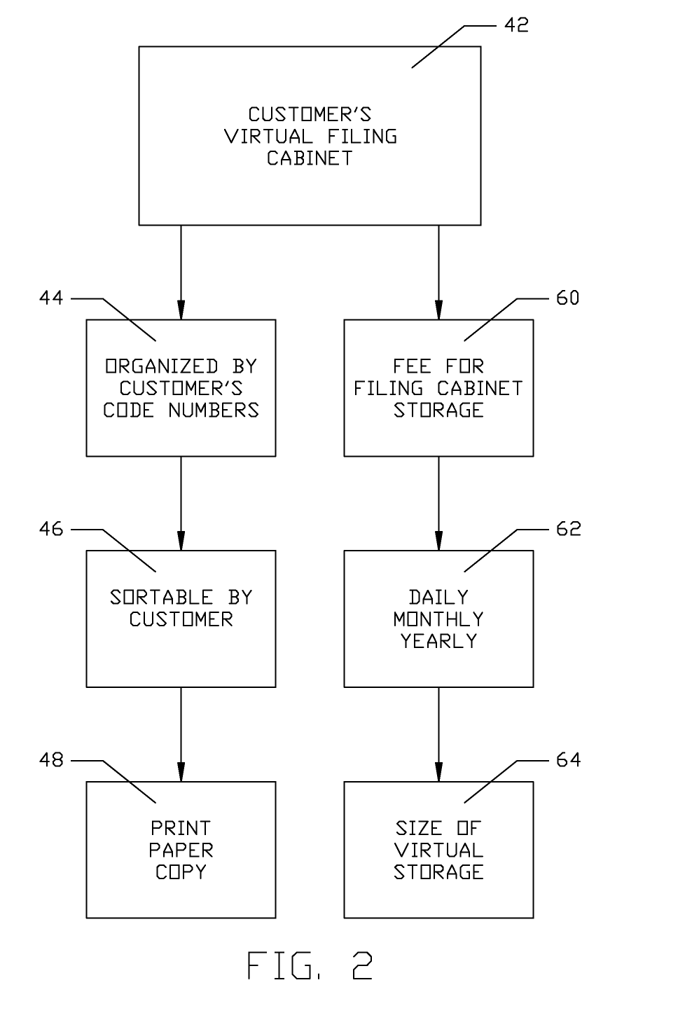

As shown in FIG. 2, the reader's virtual filing cabinet 42 organizes the stored articles 44 by subject matter based on the way the codes have been assigned by the publisher. The reader may also modify the organization of the articles and sort the articles 46 in various manners according to the needs of the reader. The reader may also print paper copies 48 of the articles if the fees charged to the reader include printing permission. Likewise, these articles may also be electronically transferred to other customers if the reader has paid for this feature.

Any suitable fee schedule can be implemented. Typically, the reader would pay a fee for using the filing cabinet storage feature 60. The fee could be per component fee or a daily, monthly or yearly fee 62 and could also be based on the size of the virtual storage 64 utilized by the reader.

As a subscriber to the system, the reader would only have access to articles that he has electronically clipped as well as a library of articles that were scanned with the permission of the owners or publishers of the articles. The system could also include public domain articles that would not require payment to the copyright owner.

The publishers of newspapers, magazines and books would hopefully be persuaded to print the codes for use in the system at the beginning of each article. The present invention would provide a way for publishers to monetize their online content.

If publishers decline to participate, the reader could type in a code number for the magazine and a page number for the article. The codes for the magazines could be stored on the cell phone. For example Forb 04-07-2007-34 would be Forbes Apr. 7, 2007 page 34. The reader might be required as well to enter the first word of the article to show that they have read it.

In summary, a method for information archiving and retrieving comprises providing components of information, each component being provided with a unique alpha-numeric code that is both in a machine-readable format and in a human-readable format. A user selects each component that the user wishes to archive by using an access device to record the alpha-numeric code into the access device. The alpha-numeric code is stored in the access device by having the access device read the machine-readable code or by having the user enter the hand-readable code into the access device.

Then the user uses the access device to communicate with an information archival service to transmit the recorded codes from the user's device to the information archival service. The information archival service organizes the component in a personal virtual filing cabinet for the user. The components can be organized by subject matter based on the code assigned to the component or in a manner designated by the user based on the code assigned to the component.

The user accesses the information archival service to obtain an electronic copy of the component which the user desires to archive. The information archival service charges the user a fee. The information archival service can charge the user on a per-article basis or on a time basis for a limited or unlimited quantity of information.

While the invention has been illustrated with respect to several specific embodiments thereof, these embodiments should be considered as illustrative rather than limiting. Various modifications and additions may be made and will be apparent to those skilled in the art.

What is claimed is:

1. A method for information archiving and retrieving comprising:
a) providing components of information, each component being provided with a unique alpha-numeric code that is both in a machine-readable format and in a human-readable format;
b) a user selects each component that the user wishes to archive by using an access device to record the alpha-numeric code into the access device;
c) using the access device to communicate with an information archival service to transmit the recorded codes from the user's device to the information archival service;
d) the information service organizing the component in a personal virtual filing cabinet for the user;
e) the user accessing the information archival service to obtain an electronic copy of the component which the user desires to archive; and
f) the information archival service charging the user a fee.

2. The method of claim 1 in which the alpha-numeric code is stored in the access device by having the access device read the machine-readable code.

3. The method of claim 1 in which the alpha-numeric code is stored in the access device by having the user enter the hand-readable code into the access device.

4. The method of claim 1 in which the information archival service charges the user on a per-article basis.

5. The method of claim 1 in which the information archival service charges the user on a time basis for a limited quantity of information.

6. The method of claim 1 in which the information archival service charges the user on a time basis for an unlimited quantity of information.

7. The method of claim 1 in which the information archival service organizes the component by subject matter based on the code assigned to the component.

8. The method of claim 1 in which the information archival service organizes the component in a manner designated by the user based on the code assigned to the component.
